(19) United States
(12) Patent Application Publication
(10) Pub. No.: US 2025/0345798 A1
(43) Pub. Date: Nov. 13, 2025

(54) MICROFLUIDIC DEVICE

(71) Applicant: GIST(Gwangju Institute of Science and Technology), Gwangju (KR)

(72) Inventors: Sung Hoon BAE, Gwangju (KR); Sung YANG, Busan (KR); Ye Sung LEE, Busan (KR)

(73) Assignee: GIST(Gwangju Institute of Science and Technology), Gwangju (KR)

(21) Appl. No.: 19/202,485

(22) Filed: May 8, 2025

(30) Foreign Application Priority Data
May 13, 2024 (KR) 10-2024-0062654

(51) Int. Cl. B01L 3/00

(52) U.S. Cl. CPC B01L 3/502761; B01L 2200/0652; B01L 2300/087; B01L 2300/0877; B01L 2400/084

(57) ABSTRACT

The present disclosure relates to a microfluidic device that enables rapid high-throughput separation because it can separate particles in a fluid on the basis of their sizes through a simple method of passing a fluid without using external forces such as electric force, magnetic force, and acoustic radiation force.

### CROSS REFERENCE TO RELATED APPLICATION

The present application claims priority to Korean Patent Applications No. 10-2024-0062654, filed May 13, 2024 the entire contents of which are incorporated herein for all purposes by this reference.

### BACKGROUND

### Technical Field

The present disclosure relates to a microfluidic device that can separate particles in fluids on the basis of the sizes of the fluids.

### Description of the Related Art

Microparticles in the blood consist of red blood cells, white blood cells, bacteria, cancer cells, etc.

Among them, red blood cells are an essential component in blood transfusions and enable the maintenance of life. On the other hand, white blood cells, bacteria, and cancer cells can cause immune system abnormalities or rejection reactions in the recipient during blood transfusion, whereby they may lead to serious side effects.

Accordingly, various attempts have been made to use microfluidic devices to separate only red blood cells from the blood. However, since microfluidic devices of the related art separate microparticles using external forces such as electric force, magnetic force, and acoustic radiation force, the product design is complex and they are unsuitable for blood transfusion because they can only process blood under low-flow conditions.

Considering the matters described above, there is currently a demand for the development of a microfluidic device that does not use external forces and can process blood even under high-flow conditions.

### SUMMARY

An objective of the present disclosure is to selectively separate particles in fluids on the basis of the sizes of the particles through the structure of channels without using external forces.

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

A microfluidic device according to an embodiment of the present disclosure includes: a first channel extending in a longitudinal direction; and a second channel extending over and in parallel with the first channel and vertically connected with the first channel, wherein a width of the second channel gradually decreases in a flow direction of the fluid.

The present disclosure, unlike the microfluidic devices of the related art, has the advantage that since it can separate particles on the basis of their sizes through a simple method of passing a fluid without using external forces such as electric force, magnetic force, and acoustic radiation force, it enables rapid high-throughput separation, and accordingly, it can be used in various fields such as rapid diagnosis using blood, fluid purification, microplastic removal, and blood transfusion.

Detailed effects of the present disclosure in addition to the above effects will be described with the following detailed description for accomplishing the present disclosure.

### BRIEF DESCRIPTION OF THE DRAWINGS

FIG. 1 is a perspective view of a microfluidic device according to an embodiment of the present disclosure;

FIG. 2 is a cross-sectional view of the microfluidic device;

FIG. 3 is an A-A′ cross-sectional view showing the velocity of a fluid and movement of microparticles;

FIG. 4 is a B-B′ cross-sectional view showing the velocity of a fluid and movement of microparticles;

FIG. 5 is a C-C′ cross-sectional view showing the velocity of a fluid and movement of microparticles;

FIG. 6 is a view showing movement of a fluid in the C-C′ cross-section; and

FIG. 7 is a perspective view of a microfluidic device according to another embodiment of the present disclosure.

### DETAILED DESCRIPTION

The objectives, characteristics, and advantages will be described in detail below with reference to the accompanying drawings, so those skilled in the art may easily achieve the spirit of the present disclosure. However, in describing the present disclosure, detailed descriptions of well-known technologies will be omitted so as not to obscure the description of the present disclosure with unnecessary details. Hereinafter, exemplary embodiments of the present disclosure will be described with reference to accompanying drawings. The same reference numerals are used to indicate the same or similar components in the drawings.

Although terms “first”, “second”, etc. are used to describe various components in the specification, it should be noted that these components are not limited by the terms. These terms are used to discriminate one component from another component and it is apparent that a first component may be a second component unless specifically stated otherwise.

Further, in this specification, when a certain configuration is disposed “over (or under)” or “on (beneath)” of a component in the following description, it may mean not only that the certain configuration is disposed on the top (or bottom) of the component, but that another configuration may be interposed between the component and the certain configuration disposed on (or beneath) the component.

Further, in this specification, when a certain component is “connected”, “coupled”, or “jointed” to another component, it should be understood that the components may be directly connected or jointed to each other, but another component may be “interposed” between the components or the components may be “connected”, “coupled”, or “jointed” through another component.

Further, singular forms that are used in this specification are intended to include plural forms unless the context clearly indicates otherwise. In the present disclosure, terms “configured”, “include”, or the like should not be construed as necessarily including several components or several steps described herein, in which some of the components or steps may not be included or additional components or steps may be further included.

Further, in this specification, the term “A and/or B” stated in the specification means that A, B, or A and B unless specifically stated otherwise, and the term “C to D” means that C or more and D or less unless specifically stated otherwise.

The present disclosure relates to a microfluidic device that can separate particles in fluids on the basis of the sizes of the particles. Hereafter, a microfluidic device of the present disclosure is described in detail with reference to the drawings.

The structure of the microfluidic device is described first in detail, and then the flow of a fluid generated by the structure is described.

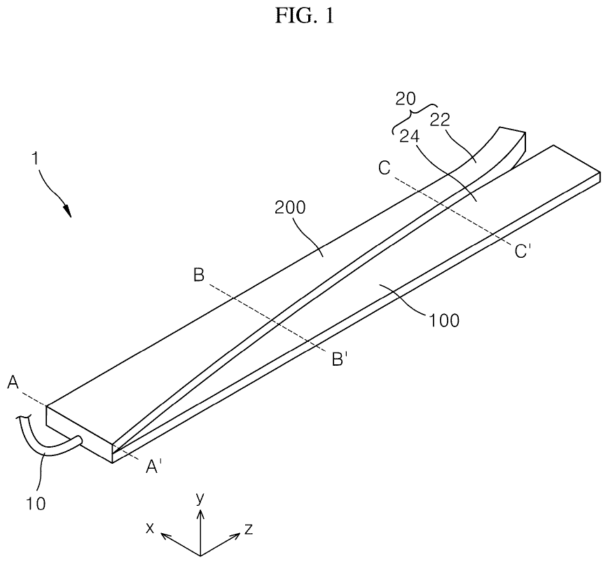

Referring to FIG. 1, a microfluidic device 1 may include first and second channels 100 and 200, and an inlet 10 and a plurality of outlets 20 that are respectively formed on a side and another side of the first and second channels 100 and 200.

However, the microfluidic device 1 shown in FIG. 1 is based on an embodiment, the structure of the present disclosure is not limited to the embodiment shown in FIG. 1, and if necessary, some components may be added, changed, or removed.

The first channel 100 may extend in the longitudinal direction, that is, the z-axis direction. The second channel 200 may extend over and in parallel with the first channel 100.

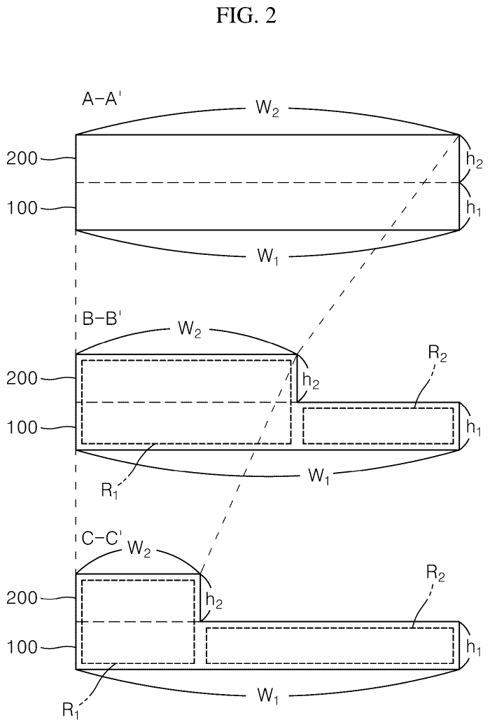

Referring to FIG. 2, a first side wall of the first channel 100 may be arranged in a straight line with a first side wall of the second channel 200.

The first channel 100 and the second channel 200 may be vertically connected with each other, so the first and second channels 100 and 200 may form an internal space.

Meanwhile, the width of the second channel 200 may gradually decrease in a fluid flow direction and may gradually decrease toward the first side wall of the first channel 100. Accordingly, the internal space of the first and second channels 100 and 200 may change.

In detail, referring to the A-A′ cross-section in FIG. 2, the widths w₁ and w₂ of the first and second channels 100 and 200 may be the same.

Next, referring to the B-B′ cross-section and the C-C′ cross-section in FIG. 2, the width of the second channel may gradually decrease in the x-axis direction as a fluid flows in the z-axis direction in FIG. 1.

Accordingly, the internal space defined by the first and second channels 100 and 200 may include a first region R1 having a total height of h1+h2 of the first and second channels 100 and 200, and a second region R2 having only the height h1 of the first channel 100. The area of the first region R1 may gradually decrease and the area of the second region R2 may gradually increase.

Area variation of the first and second regions R1 and R2 described with reference to FIG. 2 may influence the flow of a fluid, which will be described below.

Referring to FIG. 1 again, the plurality of outlets 20 may include first and second outlets 22 and 24 for separately discharging particles in a fluid on the basis of their sizes. The first and second outlets 22 and 24 may be respectively connected with the first region R1 and the second region R2 described above.

The structure of the microfluidic device 1 according to an embodiment of the present disclosure was described above, and hereafter, the flow of a fluid in the microfluidic device 1 is described in detail.

The fluid may be various types of fluid containing microparticles, such as blood, seawater, fresh water, and contaminated water. However, in the present disclosure, the fluid is referred to as blood for descriptive purposes. Blood may contain red blood cells, white blood cells, and foreign substances such as bacteria or cancer cells. Meanwhile, foreign substances may be smaller in size than red blood cells.

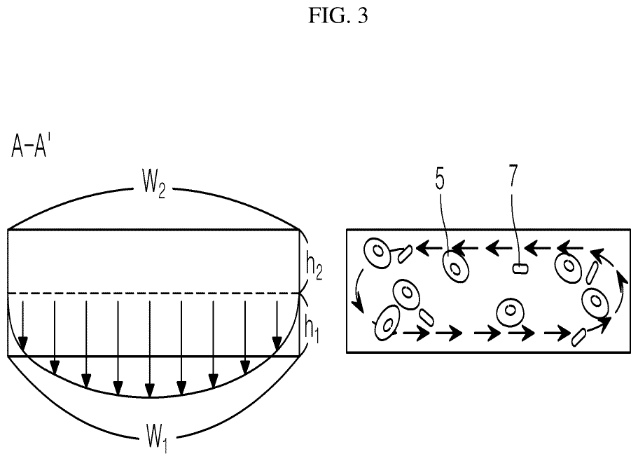

Referring to FIG. 3, blood can be injected into the internal space through the inlet 10 and can flow in the flow direction of blood, that is, in the z-axis direction, and its velocity can gradually increase at the inlet 10.

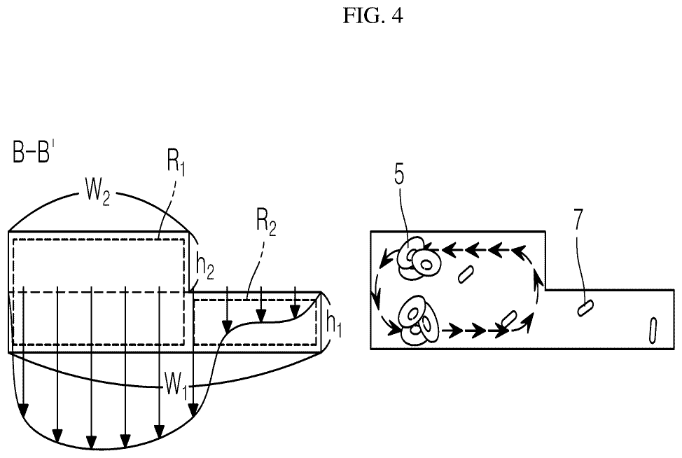

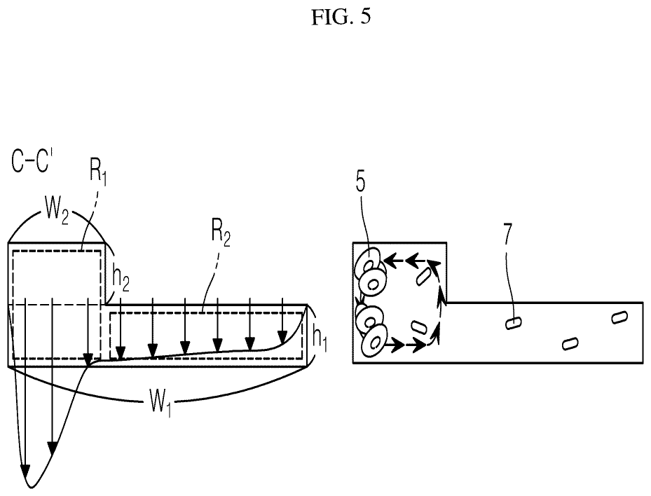

Next, referring to FIG. 4 and FIG. 5, the width W₂ of the second channel 200 may gradually decrease while blood moves in the z-axis direction, and as the cross-sectional area of the internal space of the channels changes, fluid resistance may decrease in the second region R2 and may increase in the first region R1.

However, assuming that the height of the first region R1 is n time larger than the height of the second region R2, the fluid resistance in the first region R1 has a smaller value than the fluid resistance in the second region R2 when the width of the second region R2 is n³ times smaller than the width of the first region R1.

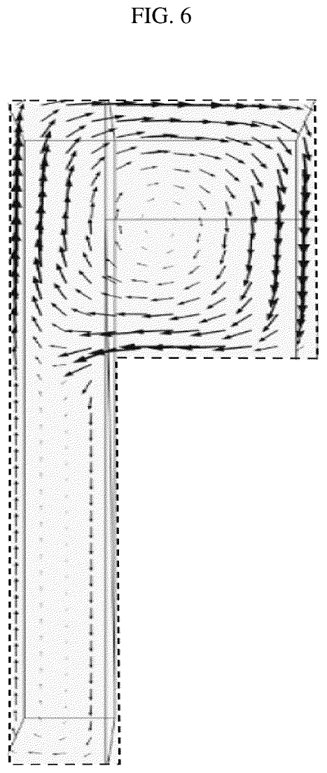

Accordingly, secondary flow may be generated due to the difference of fluid resistance between the first region R1 and the second region R2. In this case, the secondary region may increase, as the width W₂ of the second channel 200 gradually decreases, and, as shown in FIG. 6, a vortex may also be induced in the first region R1. As a result, the flow rate and velocity of blood may increase in the first region R1 in which the fluid resistance is low.

Meanwhile, red blood cells 5 and foreign substances 7 in blood may move to the first region R1 due to secondary flow. Accordingly, the red blood cells 5 and foreign substances 7 may be influenced by a vortex. In this case, the red blood cells 5 with relatively large size and inertia may be trapped in the first region R1 due to a vortex or may be concentrated at a point where the net lift force, which is the sum of a wall-induced lift force fw generated between the channel inner wall of the first region (R1) and the red blood cells, and a shear gradient force fs caused by a velocity gradient, balances with a drag force induced by the secondary flow, that is, the point where the total net force becomes zero. However, the foreign substances with relatively small size and inertia may circulate along the vortex generated by the secondary flow, but may not be concentrated.

In this way, the red blood cells 5 and the foreign substances 7 that are different in size in blood can be separated with flow of the fluid, and, finally, they can be separated through the outlets 20 connected to the first and second regions R1 and R2, respectively. In detail, blood containing the red blood cells 5 can be discharged through only a first outlet 22 connected with the first region R1 and blood containing the foreign substances 7 can be discharged to the outside through the first outlet 22 and the second outlet 24 connected with the second region R2.

Accordingly, the present disclosure, unlike the microfluidic devices of the related art, has the advantage that since it can separate particles in a fluid on the basis of their sizes through a simple method of passing a fluid without using external forces such as electric force, magnetic force, and acoustic radiation force, it enables rapid high-throughput separation, and accordingly, it can be used in various fields such as rapid diagnosis using blood, fluid purification, microplastic removal, and blood transfusion.

The structure of the microfluidic device according to an embodiment of the present disclosure and flow of a fluid therein were described above, and next, the components of a microfluidic device 2 of another embodiment are described.

Another embodiment has similar structure to that the above embodiment, so the structure is described with reference to the previously cited figures again, and similarly, the flow of a fluid according to the structure of another embodiment is the same as that of the above embodiment, so its detailed description is omitted.

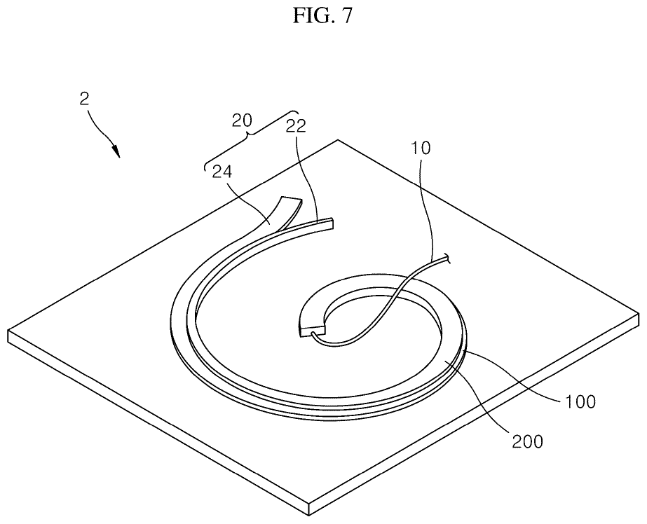

Referring to FIG. 7, a microfluidic device 2 may include first and second channels 100 and 200, and an inlet 10 and a plurality of outlets 20 that are respectively formed on a side and another side of the first and second channels 100 and 200.

The first channel 100 may be formed in a spiral shape of which the radius increases in the fluid flow direction. In the embodiment shown in FIG. 7, the fluid flow direction may be the circumferential direction in which the fluid moves from the inlet 10 to the outlets 20.

The second channel 200 may extend over and in parallel with the first channel 100.

In this case, referring to FIG. 2 again, the inner wall of the first channel 100 may be arranged in a straight line with the inner wall of the second channel 200.

The first channel 100 and the second channel 200 may be vertically connected with each other, so the first and second channels 100 and 200 may form an internal space.

Meanwhile, the width of the second channel 200 may gradually decrease in a fluid flow direction and the inner wall with a minimum centrifugal force of both side walls of the first channel 100 may gradually decrease. Accordingly, the internal space of the first and second channels 100 and 200 may change.

In detail, referring to the A-A′ cross-section in FIG. 2 again, the widths w₁ and w₂ of the first and second channels 100 and 200 may be the same.

Next, referring to the B-B′ cross-section and the C-C′ cross-section in FIG. 2 again, the width w₂ of the second channel 200 may gradually increase in the fluid flow direction. Accordingly, the internal space defined by the first and second channels 100 and 200 may include a first region R₁ having a total height of h₁+h₂ of the first and second channels 100 and 200, and a second region R₂ having only the height h₁ of the first channel 100. The area of the first region R1 may gradually decrease and the area of the second region R2 may gradually increase.

Referring to FIG. 7 again, the plurality of outlets 20 may include first and second outlets 22 and 24 for separately discharging particles in a fluid on the basis of their sizes. The first and second outlets 22 and 24 may be connected with the first region R1 and the second region R2, respectively.

The process in which particles are separated due to variation of the cross-sectional areas of the first and second regions R1 and R2 is the same as that described with reference to FIG. 3 to FIG. 5, so its detailed description is omitted here.

However, in the embodiment shown in FIG. 7, the intensity of secondary flow may be increased due to the difference of centrifugal forces applied to the inner wall and the outer wall, as compared with the embodiment shown in FIG. 1, and accordingly, the separation efficiency of particles may be higher.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

What is claimed is:

1. A microfuidic device comprising:
a first channel extending in a longitudinal direction; and
a second channel extending over and in parallel with the first channel and vertically connected with the first channel, wherein a width of the second channel gradually decreases in a flow direction of the fluid.

2. The microfuidic device of claim 1, wherein a first side wall of the first channel and a first side wall of the second channel are arranged in a straight line with each other.

3. The microfuidic device of claim 1, wherein the first and second channels form an internal space by being connected with each other, and
the internal space includes a first region having a total height of the first and second channels, and a second region having only the height of the first channel.

4. The microfuidic device of claim 3, wherein as the width of the second channel decreases, the larger the particle size of microparticles in the fluid, the more the microparticles move to the first region.

5. The microfuidic device of claim 1, further comprising first and second outlets for discharging particles in a fluid on the basis of the sizes of the particles at other sides of the first and second channels.

6. The microfuidic device of claim 3, further comprising first and second outlets connected with the first and second regions.

7. A microfluidic device comprising:
a first channel extending in a spiral shape of which a radius increases in a flow direction of a fluid; and
a second channel extending over and in parallel with the first channel and vertically connected with the first channel,
wherein a width of t the second channel gradually decreases in the flow direction of the fluid.

8. The microfluidic device of claim 7, wherein the width of the second channel gradually decreases to an inner wall with a minimum centrifugal force of both side walls of the first channel, and the inner wall of the first channel and an inner wall of the second channel are arranged in a straight line.

9. The microfluidic device of claim 7, wherein the first and second channels form an internal space by being connected with each other, and
the internal space includes a first region having a total height of the first and second channels and being in contact with inner walls of the first and second channels, and a second region having the height of the first channel and being in contact with an outer wall of the first channel.

10. The microfluidic device of claim 9, wherein as the width of the second channel decreases, the larger the particle size of microparticles in the fluid, the more the microparticles move to the first region.

11. The microfluidic device of claim 7, wherein first and second outlets for discharging particles in a fluid on the basis of the sizes of the particles at other sides of the first and second channels.

12. The microfluidic device of claim 9, wherein first and second outlets connected with the first and second regions.
